(19) United States
(12) Patent Application Publication
(10) Pub. No.: US 2026/0366344 A1
(43) Pub. Date: Nov. 19, 2026

(54) Cargo Door Lock

(71) Applicant: B&B Lock Company, Claysburg, PA (US)

(72) Inventor: Dustin Izing, Claysburg, PA (US)

(21) Appl. No.: 19/675,697

(22) Filed: May 13, 2026

Related U.S. Application Data
(60) Provisional application No. 63/804,789, filed on May 13, 2025.

(51) Int. Cl. E05B 83/02

(52) U.S. Cl. CPC E05B 83/02

(57) ABSTRACT

A door lock assembly for a cargo container includes: a first shaft member having a first securing hook; a second shaft member having a second securing hook, the second shaft member sized and configured to couple to the first shaft member; and a shaft member shield including: a first shielding component attached to the first shaft member; a second shielding component attached to the second shaft member; where the first shielding component is sized and configured to surround the first shaft member; where the second shielding component is sized and configured to surround the second shaft member; where the first securing hook is sized and configured to fit around a first rod on a first door of a cargo container and where the second securing hook is sized and configured to fit around a second rod on a second door of the cargo container.

### CROSS REFERENCE TO RELATED APPLICATION

This application claims the benefit of United States Provisional Patent Application No. 63/804,789, filed May 13, 2025, the disclosure of which is hereby incorporated by reference in its entirety.

### BACKGROUND

### Field of the Disclosure

The present disclosure relates generally to anti-theft devices. More specifically, the disclosure relates to a cargo door lock for securing the doors of a container.

### Description of the Related Art

The world relies on supply chains to get goods from the supplier to the customer. For example, a significant portion of manufactured goods reaches customers via supply chains that rely heavily on cargo containers that include sea-rail containers and tractor-trailer containers. However, cargo containers may be vulnerable to cargo theft, such as theft of merchandise that is in transit. Theft of merchandise from containers can occur anywhere along the supply chain including, but not limited to, seaports, railroad terminals, truck terminals, and truck stops. Theft of merchandise from cargo containers may cause insurance losses and a considerable amount of disruption. To claim theft insurance requires filing an insurance claim and reporting the theft to the relevant authorities. Preparing and filing paperwork uses personnel resources and causes disruption in the otherwise smooth transport of merchandise in cargo containers. Cargo containers may also be used in a static role; for example, a tractor-trailer type of container is sometimes used on construction sites to store building materials.

Many cargo containers have a configuration where the rear doors are fitted with a pair of vertical rods used to secure the rear doors of a cargo container. The vertical rods may have handles that are rotated to allow for opening and closing of the rear doors. In some instances, locks for cargo doors have been designed to fit around the vertical rods to secure the rear doors. However, such lock designs may be susceptible to unauthorized removal, for example, by cutting the lock.

### SUMMARY

In some non-limiting aspects of the present disclosure, a door lock assembly for a cargo container includes: a first shaft member having a first securing hook; a second shaft member having a second securing hook and where the second shaft member is sized and configured to couple to the first shaft member; and a shaft member shield including: a first shielding component attached to the first shaft member; a second shielding component attached to the second shaft member; where the first shielding component is sized and configured to surround the first shaft member; where the second shielding component is sized and configured to surround the second shaft member; where the first securing hook of the first shaft member is sized and configured to fit around a first rod on a first door of a cargo container and where the second securing hook of the second shaft member is sized and configured to fit around a second rod on a second door of the cargo container.

The first shielding component and the second shielding component overlap when the second shaft member and the first shaft member are coupled together. The first securing hook includes a two-pronged hook, where the two-pronged hook includes a first prong, a second prong, and a space defined between the first prong and the second prong, where the two-pronged hook is sized and configured to fit around the first rod on the first door of the cargo container and the first prong and the second prong fit above and below a bracket that holds the first rod on the first door of the cargo container. The first shielding component includes a first upper section, a first middle section, and a first lower section, where the first upper section, the first middle section, and the first lower section define a first U-shaped profile that surrounds the first shaft member; and where the second shielding component includes a second upper section, a second middle section, and a second lower section, where the second upper section, the second middle section, and the second lower section define a second U-shaped profile that surrounds the second shaft member. The first shielding component includes a first U-shaped open end, where the first securing hook includes a first prong section and a first base section, where the first base section includes a shape that corresponds to the first U-shaped open end. The second shielding component includes a second U-shaped open end, where the second securing hook includes a second prong section and a second base section, where the second base section includes a shape that corresponds to and overlaps the second U-shaped open end. The second shaft member is sized and configured to fit at least partially within the first shaft member when the first shaft member and the second shaft member are coupled together. The first shielding component includes a first curved prong, where the first curved prong is sized and configured to partially surround the first rod on the first door of the cargo container; and where the second shielding component includes a second curved prong, where the second curved prong is sized and configured to partially surround the second rod on the second door of the cargo container.

In some non-limiting aspects of the present disclosure, a door lock assembly for a cargo container includes: a first lock section having a first two-pronged securing hook; and a second lock section having a second two-pronged securing hook and where the second shaft member is sized and configured to couple to the first shaft member; and where the first two-pronged securing hook of the first lock section is sized and configured to fit around a first rod on a first door of a cargo container; and where the second two-pronged securing hook of the second lock section is sized and configured to fit around a second rod on a second door of the cargo container; and where each of the first two-pronged securing hook and the second two-pronged securing hook includes a first prong, a second prong, and a space defined between the first prong and the second prong, where the first prong and the second prong fit above and below a respective bracket that holds a respective rod on a respective door of the cargo container.

The first lock section includes a first shaft member; and where the second lock section includes a second shaft member; and where the second shaft member is sized and configured to fit at least partially within the first shaft member when the first shaft member and the second shaft member are coupled together. The first lock section includes a first curved prong, where the first curved prong is sized and configured to partially surround the first rod on the first door of the cargo container; and where the second lock section includes a second curved prong, where the second curved prong is sized and configured to partially surround the second rod on the second door of the cargo container. The first lock section includes a first shaft member and a first shielding component attached to the first shaft member; and where the second lock section includes a second shaft member and a second shielding component attached to the second shaft member; and where the first shielding component is sized and configured to surround the first shaft member; and where the second shielding component is sized and configured to surround the second shaft member; and where the first shielding component and the second shielding component prevents access to outward facing surfaces of the first shaft member and the second shaft member when the second shaft member and the first shaft member are coupled together. The first shielding component and the second shielding component overlap when the second shaft member and the first shaft member are coupled together. The first shielding component includes a first upper section, a first middle section, and a first lower section, where the first upper section, the first middle section, and the first lower section define a first U-shaped profile that surrounds the first shaft member; and where the second shielding component includes a second upper section, a second middle section, and a second lower section, where the second upper section, the second middle section, and the second lower section define a second U-shaped profile that surrounds the second shaft member. The first shielding component includes a first U-shaped open end, where the first securing hook includes a first prong section and a first base section, where the first base section includes a shape that corresponds to the first U-shaped open end. The second shielding component includes a second U-shaped open end, where the second securing hook includes a second prong section and a second base section, where the second base section includes a shape that corresponds to and overlaps the second U-shaped open end.

In some non-limiting aspects of the present disclosure, a door lock assembly for a cargo container includes: a first lock section including a first shaft member having a first two-pronged securing hook and a first shielding component attached to the first shaft member; and a second lock section including a second shaft member having a second two-pronged securing hook and a second shielding component attached to the first shaft member, where the second shaft member is sized and configured to couple to the first shaft member; and where the first shielding component is sized and configured to surround the first shaft member; and where the second shielding component is sized and configured to surround the second shaft member; where the first two-pronged securing hook of the first lock section is sized and configured to fit around a first rod on a first door of a cargo container; and where the second two-pronged securing hook of the second lock section is sized and configured to fit around a second rod on a second door of the cargo container; and where each of the first two-pronged securing hook and the second two-pronged securing hook includes a first prong, a second prong, and a space defined between the first prong and the second prong, where the first prong and the second prong fit above and below a respective bracket that holds a respective rod on a respective door of the cargo container.

### BRIEF DESCRIPTION OF THE DRAWINGS

FIG. 1 is a perspective view of a cargo door lock, according to some non-limiting aspects of the present disclosure;

FIG. 2 is a perspective view of a cargo door lock, according to some non-limiting aspects of the present disclosure;

FIG. 3 is an exploded view of a cargo door lock, according to some non-limiting aspects of the present disclosure;

FIG. 4 is a perspective view of a locking section of a cargo door lock, according to some non-limiting aspects of the present disclosure;

FIG. 5 is a perspective view of a locking section of a cargo door lock, according to some non-limiting aspects of the present disclosure;

FIG. 6 is a perspective view of a securing hook of a cargo door lock, according to some non-limiting aspects of the present disclosure;

FIG. 7 is a perspective view of a securing hook of a cargo door lock, according to some non-limiting aspects of the present disclosure;

FIG. 8 is a perspective view of a shielding component of a cargo door lock, according to some non-limiting aspects of the present disclosure;

FIG. 9 is a perspective view of a shielding component of a cargo door lock, according to some non-limiting aspects of the present disclosure; and

FIG. 10 is a perspective view of a cargo door lock installed on a cargo container, according to some non-limiting aspects of the present disclosure.

### DETAILED DESCRIPTION

For purposes of the following detailed description, it is to be understood that the disclosure may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present disclosure.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

Further, the terms “upper,” “lower,” “right,” “left,” “vertical,” “horizontal,” “top,” “bottom,” “lateral,” “longitudinal,” and derivatives thereof shall relate to the disclosure and/or embodiments as it is oriented in the drawing figures. However, it is to be understood that the disclosure and/or embodiments may assume alternative variations and step sequences, except where expressly specified to the contrary. It is also to be understood that the specific embodiments and processes illustrated in the attached drawings, and described in the specification, are simply exemplary embodiments of the disclosure. Hence, specific dimensions and other physical characteristics related to the embodiments disclosed herein are not to be considered as limiting.

Some non-limiting embodiments or aspects may be described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

Non-limiting embodiments of the present disclosure are generally directed to anti-theft devices, such as, for example, a cargo door lock for securing the doors of a container. In this way, a cargo door lock is provided with the benefit of preventing and/or aiding in preventing theft of cargo of a cargo container and shielding the cargo door lock from cutting.

In some non-limiting aspects of the present disclosure, a door lock assembly for a cargo container may include: a first shaft member having a first securing hook; a second shaft member having a second securing hook and where the second shaft member may be sized and configured to couple to the first shaft member; and a shaft member shield including: a first shielding component attached to the first shaft member; a second shielding component attached to the second shaft member; where the first shielding component may be sized and configured to surround the first shaft member; where the second shielding component may be sized and configured to surround the second shaft member; where the first securing hook of the first shaft member may be sized and configured to fit around a first rod on a first door of a cargo container and where the second securing hook of the second shaft member may be sized and configured to fit around a second rod on a second door of the cargo container. In this way, a cargo door lock is provided with the benefit of preventing and/or aiding in preventing theft of cargo of a cargo container by shielding the cargo door lock from cutting.

The first shielding component and the second shielding component may overlap when the second shaft member and the first shaft member are coupled together. The first securing hook may include a two-pronged hook, where the two-pronged hook may include a first prong, a second prong, and a space defined between the first prong and the second prong, where the two-pronged hook may be sized and configured to fit around the first rod on the first door of the cargo container and the first prong and the second prong may fit above and below a bracket that holds the first rod on the first door of the cargo container. The first shielding component may include a first upper section, a first middle section, and a first lower section, where the first upper section, the first middle section, and the first lower section may define a first U-shaped profile that surrounds the first shaft member; and where the second shielding component may include a second upper section, a second middle section, and a second lower section, where the second upper section, the second middle section, and the second lower section may define a second U-shaped profile that surrounds the second shaft member. The first shielding component may include a first U-shaped open end, where the first securing hook may include a first prong section and a first base section, where the first base section may include a shape that corresponds to the first U-shaped open end. The second shielding component may include a second U-shaped open end, where the second securing hook may include a second prong section and a second base section, where the second base section may include a shape that corresponds to and may overlap the second U-shaped open end. The second shaft member may be sized and configured to fit at least partially within the first shaft member when the first shaft member and the second shaft member are coupled together. The first shielding component may include a first curved prong, where the first curved prong may be sized and configured to partially surround the first rod on the first door of the cargo container; and where the second shielding component may include a second curved prong, where the second curved prong may be sized and configured to partially surround the second rod on the second door of the cargo container.

In some non-limiting aspects of the present disclosure, a door lock assembly for a cargo container may include: a first lock section having a first two-pronged securing hook; and a second lock section having a second two-pronged securing hook and where the second shaft member may be sized and configured to couple to the first shaft member; and where the first two-pronged securing hook of the first lock section may be sized and configured to fit around a first rod on a first door of a cargo container; and where the second two-pronged securing hook of the second lock section may be sized and configured to fit around a second rod on a second door of the cargo container; and where each of the first two-pronged securing hook and the second two-pronged securing hook may include a first prong, a second prong, and a space defined between the first prong and the second prong, where the first prong and the second prong may fit above and below a respective bracket that holds a respective rod on a respective door of the cargo container.

The first lock section may include a first shaft member; and where the second lock section may include a second shaft member; and where the second shaft member may be sized and configured to fit at least partially within the first shaft member when the first shaft member and the second shaft member are coupled together. The first lock section may include a first curved prong, where the first curved prong may be sized and configured to partially surround the first rod on the first door of the cargo container; and where the second lock section may include a second curved prong, where the second curved prong may be sized and configured to partially surround the second rod on the second door of the cargo container. The first lock section may include a first shaft member and a first shielding component attached to the first shaft member; and where the second lock section may include a second shaft member and a second shielding component attached to the second shaft member; and where the first shielding component may be sized and configured to surround the first shaft member; and where the second shielding component may be sized and configured to surround the second shaft member; and where the first shielding component and the second shielding component may prevent access to outward facing surfaces of the first shaft member and the second shaft member when the second shaft member and the first shaft member are coupled together. The first shielding component and the second shielding component may overlap when the second shaft member and the first shaft member are coupled together. The first shielding component may include a first upper section, a first middle section, and a first lower section, where the first upper section, the first middle section, and the first lower section may define a first U-shaped profile that surrounds the first shaft member; and where the second shielding component may include a second upper section, a second middle section, and a second lower section, where the second upper section, the second middle section, and the second lower section may define a second U-shaped profile that surrounds the second shaft member. The first shielding component may include a first U-shaped open end, where the first securing hook may include a first prong section and a first base section, where the first base section may include a shape that corresponds to the first U-shaped open end. The second shielding component may include a second U-shaped open end, where the second securing hook may include a second prong section and a second base section, where the second base section may include a shape that corresponds to and may overlap the second U-shaped open end.

In some non-limiting aspects of the present disclosure, a door lock assembly for a cargo container may include: a first lock section including a first shaft member having a first two-pronged securing hook and a first shielding component attached to the first shaft member; and a second lock section including a second shaft member having a second two-pronged securing hook and a second shielding component attached to the first shaft member, where the second shaft members may be sized and configured to couple to the first shaft member; and where the first shielding component may be sized and configured to surround the first shaft member; and where the second shielding component may be sized and configured to surround the second shaft member; where the first two-pronged securing hook of the first lock section may be sized and configured to fit around a first rod on a first door of a cargo container; and where the second two-pronged securing hook of the second lock section may be sized and configured to fit around a second rod on a second door of the cargo container; and where each of the first two-pronged securing hook and the second two-pronged securing hook may include a first prong, a second prong, and a space defined between the first prong and the second prong, where the first prong and the second prong may fit above and below a respective bracket that holds a respective rod on a respective door of the cargo container.

In this way, a cargo door lock is provided with the benefit of preventing theft of cargo of a cargo container by shielding the cargo door lock from destructive forces based on cutting (e.g., cutting with a saw or a torch), impact, and/or explosives. Furthermore, based on a shape of the base sections of the securing hooks that correspond to the U-shaped open ends of the shielding components, the cargo door lock of the present disclosure may further prevent destruction of the cargo door lock by preventing accessibility to the cargo door lock from behind the shielding components. In addition, the overlapping design of the shielding components, along with the design of the shielding components to accommodate the lock housing, provides for the ability of the cargo door lock to adjust to the size of a cargo door, while preventing destruction of the cargo door lock.

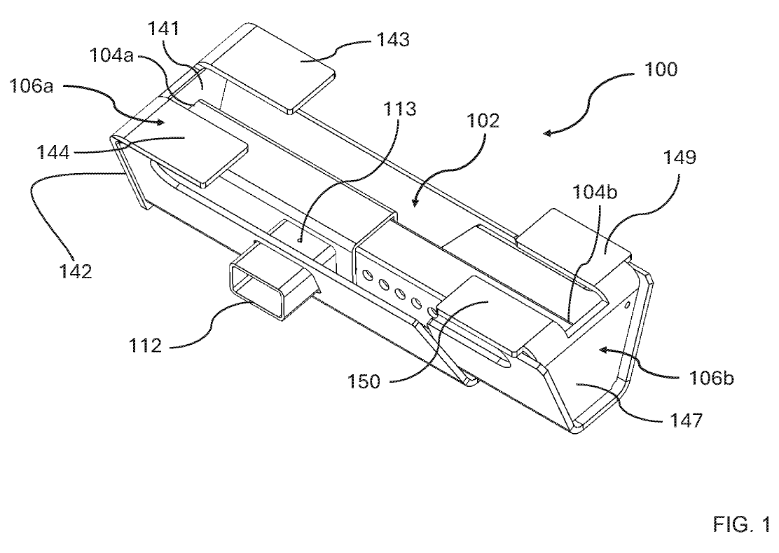

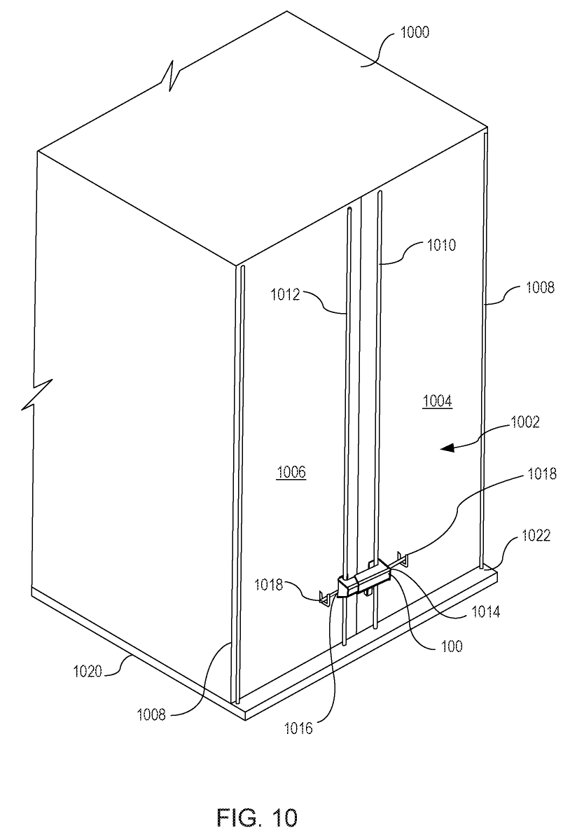

Referring to FIG. 1, in some non-limiting embodiments, cargo door lock 100 is provided. Cargo door lock 100 may include extendable shaft 102. Extendable shaft 102 may include first end 104a and second end 104b opposite from first end 104a. First end 104a of extendable shaft 102 may include first securing hook 106a and second end 104b of extendable shaft 102 may include second securing hook 106b. First securing hook 106a and second securing hook 106b may be configured to be attached to first vertical rod 1010 and second vertical rod 1012, respectively (e.g., see FIG. 10). Securing hooks 106a, 106b may face inward with respect to each other and inward from shaft ends 104a, 104b, respectively. Cargo door lock 100 may include lock housing 112 configured to contain a lock mechanism (not shown).

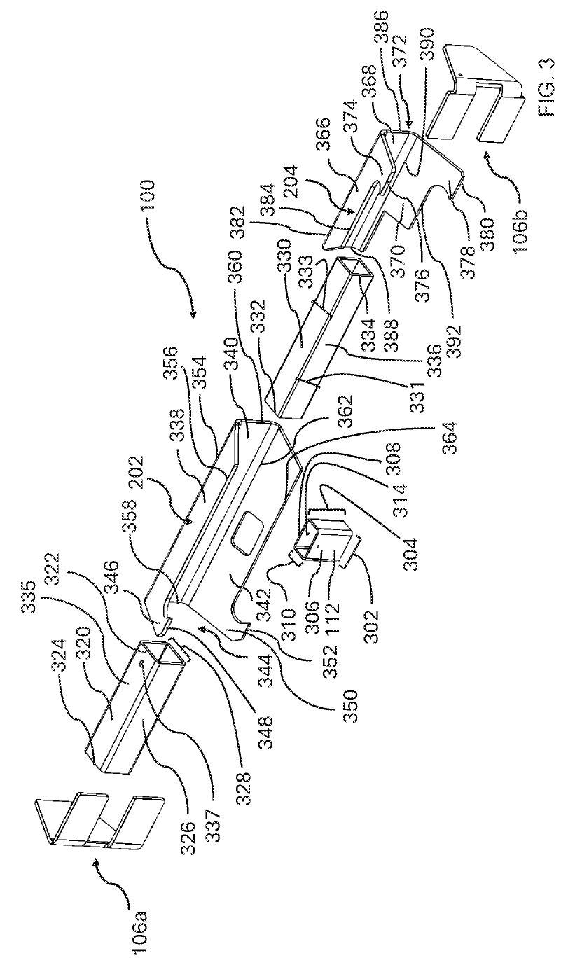

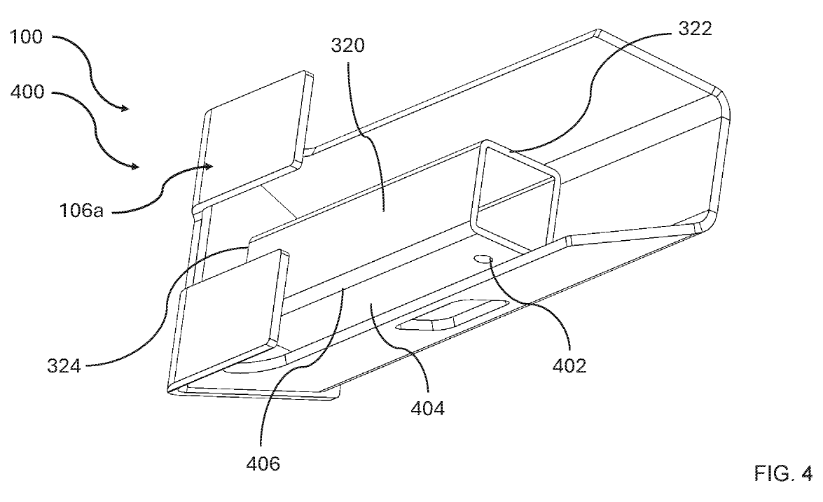

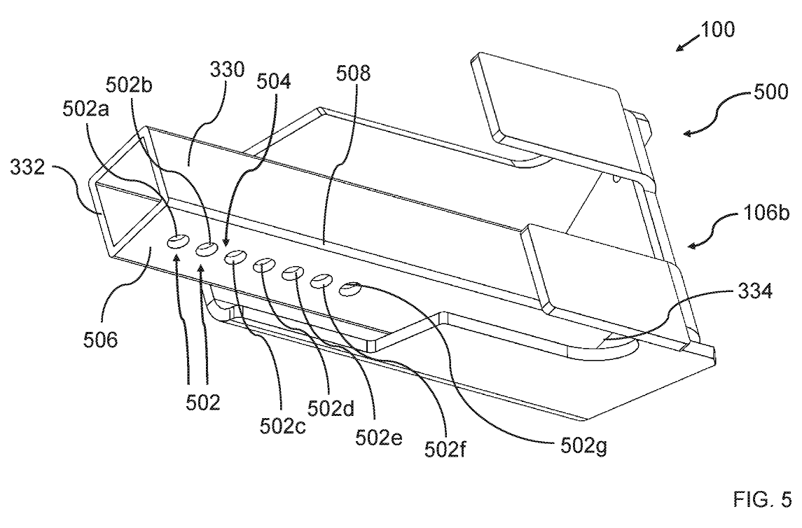

Extendable shaft 102 may have a variable length, which may be based on which hole of a plurality of holes 502 is aligned with first hole 402 (e.g., see FIGS. 4 and 5). A predetermined length selected for extendable shaft 102 may be based on the configuration of the vertical rods of a cargo container, such as, for example, rods 1010, 1012 of cargo container 1000, such as the distance between rods 1010, 1012 of cargo container 1000. Extendable shaft 102 may have a maximum length in the range of from 15 inches to 25 inches. Extendable shaft 102 may have a minimum length in the range of from 10 inches to 20 inches. The length of extendable shaft 102 may account for an overlap between shaft members, such as, for example, first shaft member 320 and second shaft member 330 of FIG. 3, such as an overlap based on second shaft member 330 being positioned at least partially within first shaft member 320.

Cargo door lock 100 may include lock housing 112 configured to contain a lock mechanism (not shown). Lock housing 112 may include any suitable material, such as a metal, such as steel. The component parts of the lock mechanism, such as a lock, are housed inside lock housing 112. Lock housing 112 may include front surface 306 and back surface 308 opposite from front surface 306. Lock housing 112 may be set at a perpendicular angle with respect to first and second securing hooks 106a, 106b, such that lock housing 112 faces downward with respect to first and second securing hooks 106a, 106b. By placing the lock mechanism inside lock housing 112, which points downward with respect to securing hooks 106a, 106b, the lock mechanism is less exposed to poor weather conditions compared to existing lock assemblies, such as that disclosed in U.S. Patent No. 5,145,222. Non-limiting examples of lock mechanisms that may be implemented as the lock mechanism for cargo door lock 100 includes the lock mechanisms disclosed in U.S. Patent No. 7,278,663, the disclosure of which is hereby incorporated by reference in its entirety. The lock mechanism may lockingly engage extendable shaft 102 at a predetermined length.

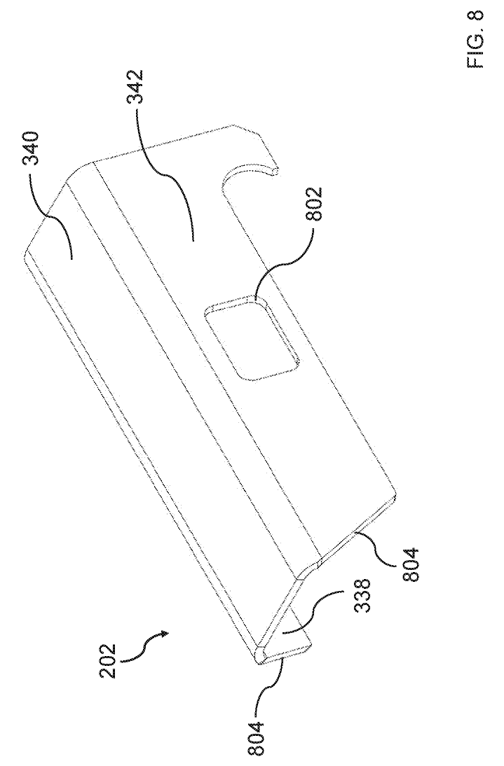

A securing member, such as a screw or a bolt, may be provided to hold the locking mechanism in situ when the lock is in an unlocked configuration. The securing member may also prevent unauthorized removal of the lock from lock housing 112. The securing member may fit through securing hole 113 located on front surface 306 of lock housing 112. Securing hole 113 may have a diameter in the range of from 0.1 inches to 0.5 inches. Securing hole 113 may be located on front surface 306 at a distance in the range of from 1 inch to 2 inches from a side surface of lock housing 112. Securing hole 113 may be located on front surface 306 at a distance in the range of from 0.25 inches to 2 inches from the end of lock housing 112 that is inserted into housing slot 802 (see FIG. 8). Optional blind hole 314 (see FIG. 3) may be located on back surface 308 of lock housing 112 to secure the securing member, thereby preventing unauthorized removal of the lock mechanism. Blind hole 314 may have a diameter in the range of from 0.1 inches to 0.5 inches. Blind hole 314 may be located on back surface 308 at a distance in the range of from 1 inch to 2 inches from a side surface of lock housing 112. Blind hole 314 may be located on back surface 308 at a distance in the range of from 0.25 inches to 2 inches from the end of lock housing 112 that is inserted into housing slot 802.

In some non-limiting embodiments, securing hooks 106a, 106b and lock housing 112 may each independently be welded to extendable shaft 102. Alternatively, other means may be used to couple securing hooks 106a, 106b and lock housing 112 to extendable shaft 102. For example, one or more fasteners, such as securing bolts, may be used to attach securing hooks 106a, 106b and lock housing 112 to extendable shaft 102. In this regard, any suitable securing means may be used to secure securing hooks 106a, 106b and lock housing 112 to extendable shaft 102. First securing hook 106a may include first base section 141 and first prong section 143. First securing hook 106a may include any suitable material, such as a metal, such as steel. First base section 141 may include front surface 142. First prong section 143 may include upper surface 144. Second securing hook 106b may include second base section 147 and second prong section 149. Second securing hook 106b may include any suitable material, such as a metal, such as steel. Second prong section 149 may include upper surface 150. First base section 141 and second base section 147 may each independently have a trapezoidal shape. First prong section 143 and second prong section 149 may each independently comprise at least one prong that is configured to secure cargo door lock 100 to vertical rods 1010, 1012. In some non-limiting embodiments, first securing hook 106a may include first prong section 143 that includes a two-pronged hook and second securing hook 106b may include a second prong section 149 that includes a two-pronged hook.

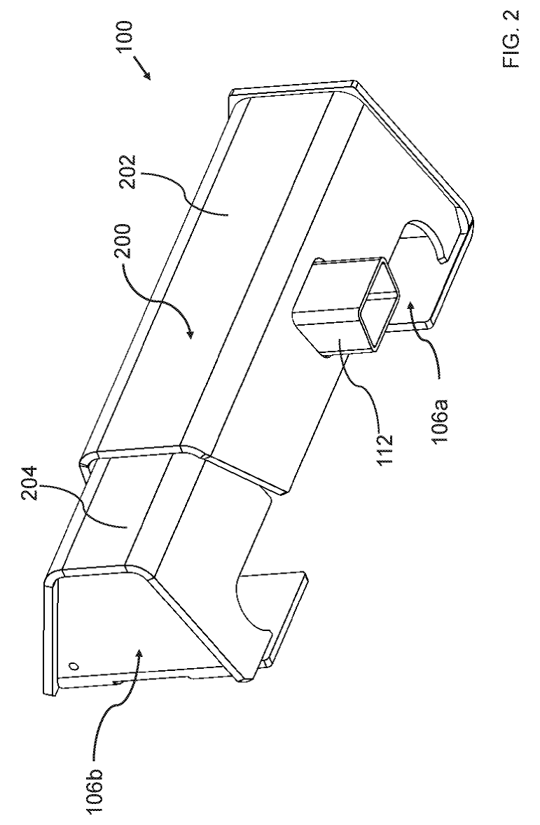

Referring to FIG. 2, in some non-limiting embodiments, cargo door lock 100 may include shaft member shield 200. Shaft member shield 200 may surround at least a portion of extendable shaft 102. For example, shaft member shield 200 may surround at least a portion of extendable shaft 102 in order to prevent access to extendable shaft 102 after cargo door lock 100 has been installed. Shaft member shield 200 may surround the portions of extendable shaft 102 that are exposed when cargo door lock 100 is installed. Shaft member shield 200 may be positioned based on the positioning of first securing hook 106a and second securing hook 106b, such that shaft member shield 200, first securing hook 106a, and second securing hook 106b combine to surround all of or substantially all of extendable shaft 102 that is exposed after installation of cargo door lock 100. Shaft member shield 200 may prevent access to extendable shaft 102 after installation of cargo door lock 100, which may prevent destruction, such as cutting, of extendable shaft 102. For example, shaft member shield 200 may prevent unauthorized access to cargo container 1000, such as preventing the unauthorized removal of cargo door lock 100, such as by preventing cutting, or similar action, of extendable shaft 102 after installation of cargo door lock 100. Shaft member shield 200 may include first shielding component 202 and second shielding component 204.

In some non-limiting embodiments, shaft member shield 200 may include first shielding component 202. First shielding component 202 may include any suitable material, such as a metal, such as steel. First shielding component 202 may be attached to first shaft member 320. First shielding component 202 may be welded to first shaft member 320. First shielding component 202 may be fastened to first shaft member 320, for example, using a suitable fastener, such as a screw or bolt. First shielding component 202 may be sized and configured to surround first shaft member 320. For example, first shielding component 202 may surround first shaft member 320 so as to prevent unauthorized access to first shaft member 320, such as to prevent cutting of first shaft member 320, after cargo door lock 100 has been installed. First shielding component 202 may include a general U-shaped profile that surrounds first shaft member 320. First shielding component 202 may include first end 358 and second end 360 opposite from first end 358. First shielding component 202 may have a length, measured from first end 358 to second end 360 of first shielding component 202, in the range of from 14 inches to 17 inches. First shielding component 202 may have a thickness in the range of from 0.125 inches to 0.75 inches.

In some non-limiting embodiments, shaft member shield 200 may include second shielding component 204. Second shielding component 204 may include any suitable material, such as a metal, such as steel. Second shielding component 204 may be attached to second shaft member 330. Second shielding component 204 may be welded to second shaft member 330. Second shielding component 204 may be fastened to second shaft member 330, for example, using a suitable fastener, such as a screw or bolt. Second shielding component 204 may be sized and configured to surround second shaft member 330. For example, second shielding component 204 may surround second shaft member 330 so as to prevent unauthorized access to second shaft member 330, such as to prevent cutting of second shaft member 330, after cargo door lock 100 has been installed. Second shielding component 204 may include a general U-shaped profile that surrounds second shaft member 330. Second shielding component 204 may include first end 386 and second end 388 opposite from first end 386. Second shielding component 204 may have a length, measured from first end 386 to second end 388 of second shielding component 204, in the range of from 8 inches to 12 inches. Second shielding component 204 may have a thickness in the range of from 0.125 inches to 0.75 inches.

First shielding component 202 and second shielding component 204 may overlap when first shaft member 320 and second shaft member 330 are coupled together, as shown in FIG. 2 . First shielding component 202 and second shielding component 204 may overlap, thereby forming shaft member shield 200 and surrounding extendable shaft 102. First shielding component 202 may overlap at least a portion of second shielding component 204, when first shaft member 320 and second shaft member 330 are coupled together. For example, at least a portion of first shielding component 202, such as at least a portion of first upper section 338, first middle section 340, and first lower section 342, may overlap at least a portion of second shielding component 204, such as at least a portion of second upper section 366, second middle section 368, and second lower section 370. Second end 360 of first shielding component 202 may overlap second end 388 of second shielding component 204.

Referring to FIG. 3, in some non-limiting embodiments, extendable shaft 102 comprises first shaft member 320 and second shaft member 330. First shaft member 320 may have proximal end 322 and distal end 324 opposite of proximal end 322. Second shaft member 330 may include proximal end 332 and distal end 334 opposite of proximal end 332. Proximal end 322 and distal end 324 of first shaft member 320 may define first middle portion 326. First shaft member 320 may include any suitable material, such as a metal, such as steel. Proximal end 332 and distal end 334 of second shaft member 330 may define second middle portion 336. Second shaft member 330 may include any suitable material, such as a metal, such as steel. Second shaft member 330 may be sized and configured to couple to first shaft member 320. Second shaft member 330 may be sized and configured to fit at least partially within first shaft member 320, when first shaft member 320 and second shaft member 330 are coupled together. For example, proximal end 332 of second shaft member 330 may fit telescopically inside proximal end 322 of first shaft member 320 to provide extendable shaft 102, with opposite ends 104a, 104b of extendable shaft 102 being distal end 324 of first shaft member 320 and distal end 334 of second shaft member 330.

In some non-limiting embodiments, lock housing 112 may include front surface 306 and back surface 308 opposite from front surface 306. Lock housing 112 may have height 310 in the range of from 2 inches to 5 inches. Lock housing 112 may have length 302 in the range of from 2 inches to 4 inches. Lock housing 112 may have width 304 in the range of from 1 inch to 4 inches.

First shaft member 320 may have a length, width, and height. First shaft member 320 may have a length, measured by the distance between proximal end 322 and distal end 324, in the range of from 5 inches to 12 inches. First shaft member 320 may have width 328 in the range of from 1.5 inch to 4 inches. First shaft member 320 may have a height, measured by the distance between first top wall 335 and first bottom wall 404, in the range of from 1.5 inch to 4 inches. First shaft member 320 may be hollow, thereby defining an internal volume of first shaft member 320. If first shaft member 320 is hollow, each side of first shaft member 320, including first bottom wall 404, may have a thickness in the range of from 0.1 inches to 0.75 inch.

Second shaft member 330 may have a length, width, and height. Second shaft member 330 may have a length that is greater than a length of first shaft member 320, such that second shaft member 330 is longer than first shaft member 320. Second shaft member 330 may have a length, measured by the distance between proximal end 332 and distal end 334 in the range of from 8 inches to 15 inches. Second shaft member 330 may have a width that is less than a width of first shaft member 320 and a height that is less than a height of first shaft member 320, such that the second shaft member 330 may be at least partially positioned within first shaft member 130. Second shaft member 330 may have width 333 in the range of from 1 inch to 3 inches. Second shaft member 330 may have height 331 in the range of from 1 inch to 3 inches. Second shaft member 330 may be hollow, thereby defining an internal volume of second shaft member 330. If second shaft member 330 is hollow, each side of second shaft member 330, including second bottom wall 506, may have a wall thickness in the range of from 0.1 inches to 0.75 inches.

In some non-limiting embodiments, first shaft member 320 may include first securing hook 106a, and second shaft member 330 may include second securing hook 106b. First securing hook 106a may be attached to distal end 324 of first shaft member 320, and second securing hook 106b may be attached to distal end 334 of second shaft member 330. Securing hooks 106a, 106b may be attached to first shaft member 320 and second shaft member 330, respectively, by any suitable means. For example, first securing hook 106a may be welded to distal end 324 of first shaft member 320, and second securing hook 106b may be welded to distal end 334 of second shaft member 330. In another example, first securing hook 106a may be fastened to distal end 324 of first shaft member 320, and second securing hook 106b may be fastened to distal end 334 of second shaft member 330, using any suitable fastener, such as a screw or bolt.

In some non-limiting embodiments, first base section 141 of first securing hook 106a may be attached to first shaft member 320, such as to distal end 324 of first shaft member 320, to attach first securing hook 106a to first shaft member 320. In some non-limiting embodiments, second base section 147 of second securing hook 106b may be attached to second shaft member 330, such as to distal end 334 of second shaft member 330, to attach second securing hook 106b to second shaft member 330. First base section 141 and second base section 147 may have any suitable shape. First base section 141 may have a shape that corresponds to first U-shaped open end 344 of first shielding component 202. Second base section 147 may have a shape that corresponds to second U-shaped open end 372 of second shielding component 204. First base section 141 and second base section 147 may each independently have a trapezoidal shape.

First shaft member 320 may include first top wall 335 opposite from first bottom wall 506. Optional second hole 337 may be positioned on first top wall 335. A location of second hole 337 on first top wall 335 may correspond to a location of first hole 402 positioned on first bottom wall 506.

First shielding component 202 may include first upper section 338, first middle section 340, and first lower section 342. First upper section 338, first middle section 340, and first lower section 342 may define a first U-shaped profile that surrounds first shaft member 320, such that first shielding component 202 surrounds first shaft member 320. First middle section 340 may have a width, measured by the distance between first upper section 338 and first lower section 342 at first middle section 340, in the range of from 2 inches to 5 inches. First shielding component 202 may form first U-shaped open end 344 at first end 358. First U-shaped open end 344 of first shielding component 202 may correspond to a shape of first base section 141 of first securing hook 106a. First upper section 338 and first lower section 342 may be positioned extending at an angle relative to first middle section 340. First upper section 338 and first lower section 342 may extend at an angle of 90º relative to first middle section 340. First upper section 338 and first lower section 342 may extend at an angle that is not 90º relative to first middle section 340. For example, first upper section 338 and first lower section 342 may extend at an angle in the range of from greater than 90º and up to 140º relative to first middle section 340. First upper section 338 and first lower section 342 may have a distance between each other. In embodiments where first upper section 338 and first lower section 342 extend at an angle of 90º relative to first middle section 340, the distance between first upper section 338 and first lower section 342 may be constant across the entire height of first upper section 338 and first lower section 342. In embodiments where first upper section 338 and first lower section 342 extend at an angle in the range of from greater than 90º and up to 140º relative to first middle section 340, the distance between first upper section 338 and first lower section 342 may increase as you move along first upper section 338 and first lower section 342 away from first middle section 340. For example, a maximum distance between first upper section 338 and first lower section 342 may be in the range of from 6 inches to 9 inches.

First upper section 338 of first shielding component 202 may include first upper section first end 354, first upper section second end 356 opposite from first upper section first end 354, and first curved prong 346 that includes first curved prong upper end 348, where first curved prong 346 extends from first upper section second end 356. First curved prong 346 of first shielding component 202 may be sized and configured to partially surround first vertical rod 1010 on first door 1004 of cargo container 1000. First curved prong 346 may have a shape that corresponds to a shape of first vertical rod 1010, such that first curved prong 346 may at least partially surround first vertical rod 1010 on first door 1004 of cargo container 1000. A distance between first upper section first end 354 and first curved prong upper end 348 may be in the range of from 4 inches to 6 inches. A distance between first upper section first end 354 and first upper section second end 356 may be in the range of from 2 inches to 4 inches. A distance between first upper section second end 356 and first curved prong upper end 348 may be in the range of from 1 inch to 3 inches.

First lower section 342 of first shielding component 202 may include first lower section first end 362, first lower section second end 364 opposite from first lower section first end 362, and second curved prong 350 that includes second curved prong upper end 352, where second curved prong 350 extends from first lower section second end 364. Second curved prong 350 of first shielding component 202 may be sized and configured to partially surround first vertical rod 1010 on first door 1004 of cargo container 1000. Second curved prong 350 may have a shape that corresponds to a shape of first vertical rod 1010, such that second curved prong 350 may at least partially surround first vertical rod 1010 on first door 1004 of cargo container 1000. First curved prong 346 may be positioned above first bracket 1014 and second curved prong 350 may be positioned below first bracket 1014, when cargo door lock 100 is installed. A distance between first lower section first end 362 and second curved prong upper end 352 may be in the range of from 4 inches to 6 inches. A distance between first lower section first end 362 and first lower section second end 364 may be in the range of from 2 inches to 4 inches. A distance between first lower section second end 364 and second curved prong upper end 352 may be in the range of from 1 inch to 3 inches.

Second shielding component 204 may include second upper section 366, second middle section 368, and second lower section 370. Second upper section 366, second middle section 368, and second lower section 370 may define a second U-shaped profile that surrounds second shaft member 330, such that second shielding component 204 surrounds second shaft member 330. Second middle section 368 may have a width, measured by the distance between second upper section 366 and second lower section 370 at second middle section 368, in the range of from 1 inch to 4 inches. Second shielding component 204 may form a second U-shaped open end 372 at first end 386. Second U-shaped open end 372 of second shielding component 204 may correspond to a shape of second base section 147 of second securing hook 106b. Second upper section 366 and second lower section 370 may be positioned extending at an angle relative to second middle section 368. Second upper section 366 and second lower section 370 may extend at an angle of 90º relative to second middle section 368. Second upper section 366 and second lower section 370 may extend at an angle that is not 90º relative to second middle section 368. For example, second upper section 366 and second lower section 370 may extend at an angle in the range of from greater than 90º and up to 140º relative to second middle section 368. Second upper section 366 and second lower section 370 may have a distance between each other. In embodiments where second upper section 366 and second lower section 370 extend at an angle of 90º relative to second middle section 368, the distance between second upper section 366 and second lower section 370 may be constant as you move along second upper section 366 and second lower section 370 away from second middle section 368. In embodiments where second upper section 366 and second lower section 370 extend at an angle in the range of from greater than 90º and up to 140º relative to second middle section 368, the distance between second upper section 366 and second lower section 370 may increase as you move along the second upper section 366 and second lower section 370 away from second middle section 368. For example, a maximum distance between second upper section 366 and second lower section 370 may be in the range of from 5 inches to 8 inches.

Second upper section 366 of second shielding component 204 may include second upper section first end 382, second upper section second end 384 opposite from second upper section first end 382, and first curved prong 374, that includes first curved prong upper end 376, where first curved prong 374 extends from second upper section second end 384. First curved prong 374 of second shielding component 204 may be sized and configured to partially surround second vertical rod 1012 on second door 1006 of cargo container 1000. First curved prong 374 may have a shape that corresponds to a shape of second vertical rod 1012 on second door 1006 of cargo container 1000. A distance between second upper section first end 382 and first curved prong upper end 376 may be in the range of from 4 inches to 6 inches. A distance between second upper section first end 382 and second upper section second end 384 may be in the range of from 2 inches to 4 inches. A distance between second upper section second end 384 and first curved prong upper end 376 may be in the range of from 1 inch to 3 inches.

Second lower section 370 of second shielding component 204 may include second lower section first end 390, second lower section second end 392 opposite from second lower section first end 390, and second curved prong 378 that includes second curved prong upper end 380, where second curved prong 378 extends from second lower section second end 392. Second curved prong 378 of second shielding component 204 may be sized and configured to partially surround second vertical rod 1012 on second door 1006 of cargo container 1000. Second curved prong 378 may have a shape that corresponds to a shape of second vertical rod 1012 on second door 1006 of cargo container 1000. First curved prong 374 may be positioned above second bracket 1016 and second curved prong may be positioned below second bracket 1016 when cargo door lock 100 is installed. A distance between second lower section first end 390 and second curved prong 378 may be in the range of from 4 inches to 6 inches. A distance between second lower section first end 390 and second lower section second end 392 may be in the range of from 2 inches to 4 inches. A distance between second lower section second end 392 and second curved prong upper end 380 may be in the range of from 1 inch to 3 inches.

In some non-limiting embodiments, second upper section 366 and second lower section 370 may be identical, such that second upper section 366 and second lower section 370 include the same shape and size. In some non-limiting embodiments, second upper section 366 and second lower section 370 may be different, such that second upper section 366 and second lower section 370 include different shapes and sizes.

Referring to FIG. 4, in some non-limiting embodiments, first shaft member 320 may include first bottom wall 404. First bottom wall 404 may include first edge 406. First bottom wall 404 of first shaft member 320 may include first hole 402. First hole 402 may be positioned on first bottom wall 404. First hole 402 may be positioned at some point along the length of first shaft member 320 on first bottom wall 404. For example, first hole 402 may be positioned along the length of first shaft member 320 in the range of 0.75 inches to 2 inches from proximal end 322 of first shaft member 320. First hole 402 may be positioned at some point along the width of first shaft member 320, such as at a center point of the width of first shaft member 320. First hole 402 may be positioned at some position along the width of first shaft member 320, relative to first edge 406 of first bottom wall 404. For example, first hole 402 may be positioned at some position along the width of first shaft member 320, at a distance in the range of from 1 inch to 2 inches from first edge 406 of first bottom wall 404. First hole 402 may have a diameter in the range of from 0.25 inches to 1 inch.

First shielding component 202, first shaft member 320, and first securing hook 106a may form first locking section 400. When assembled as first locking section 400, first locking section 400 may have a length, measured by the distance between second end 360 of first shielding component 202 to front surface 142 of first base section 141, in the range of from 14 inches to 17 inches. When assembled as first locking section 400, a distance between proximal end 322 of first shaft member 320 and front surface 142 of first base section 141 may be in the range of from 8 inches to 12 inches. When assembled as first locking section 400, a distance between first upper section second end 356 of first upper section 338 and upper surface 144 of first prong section 143 may be in the range of from 1.5 inches to 3 inches. When assembled as first locking section 400, a distance between first lower section second end 364 of first lower section 342 and upper surface 144 of first prong section 143 may be in the range of from 1.5 inches to 3 inches.

Referring to FIG. 5, second shaft member 330 may include second bottom wall 506. Second bottom wall 506 may include first edge 508. Second bottom wall 506 of second shaft member 330 may include the plurality of holes 502 arranged in row 504, such that when second shaft member 330 is moved telescopically inside first shaft member 320, first hole 402 aligns in turn with each hole of row 504 in second bottom wall 506 of second shaft member 330. The plurality of holes 502 may be positioned on second bottom wall 506. The plurality of holes 502 may include any number of holes 502. For example, plurality of holes 502 may include first hole 502a, second hole 502b, third hole 502c, fourth hole 502d, fifth hole 502e, sixth hole 502f, and seventh hole 502g. The plurality of holes 502 may be positioned along the length of second shaft member 330 on second bottom wall 506. The plurality of holes 502 may be equally spaced along the length of second shaft member 330 on second bottom wall 506. The plurality of holes 502 may be positioned along the length of second shaft member 330 on second bottom wall 506 at some distance from proximal end 332 of second shaft member 330. First hole 502a may be positioned along the length of second shaft member 330 on second bottom wall 506 at a distance in the range of from 0.5 inches to 2 inches from proximal end 332 of second shaft member 330. Second hole 502b may be positioned along the length of second shaft member 330 on second bottom wall 506 at a distance in the range of from 1.25 inches to 2.75 inches from proximal end 332 of second shaft member 330. Third hole 502c may be positioned along the length of second shaft member 330 on second bottom wall 506 at a distance in the range of from 2 inches to 3.5 inches from proximal end 332 of second shaft member 330. Fourth hole 502d may be positioned along the length of second shaft member 330 on second bottom wall 506 at a distance in the range of from 2.75 inches to 4.25 inches from proximal end 332 of second shaft member 330. Fifth hole 502e may be positioned along the length of second shaft member 330 on second bottom wall 506 at a distance in the range of from 3.5 inches to 5 inches from proximal end 332 of second shaft member 330. Sixth hole 502f may be positioned along the length of second shaft member 330 on second bottom wall 506 at a distance in the range of from 4.25 inches to 5.75 inches from proximal end 332 of second shaft member 330. Seventh hole 502g may be positioned along the length of second shaft member 330 on second bottom wall 506 at a distance in the range of from 4.75 inches to 6.5 inches from proximal end 332 of second shaft member 330.

The plurality of holes 502 may be positioned at some point along the width of second shaft member 330, such as at a center point of the width of second shaft member 330. Each hole of the plurality of holes 502 may be positioned at the same point along the width of second shaft member 330 in order to form row 504. For example, the plurality of holes 502 may be positioned at some position along the width of second shaft member 330, at a distance in the range of from 0.5 inches to 1.5 inches from first edge 508 of second bottom wall 506. The plurality of holes 502 may each independently have a diameter in the range of from 0.1 inches to 1 inch. In some non-limiting embodiments, the lock mechanism may be set by adjusting the length of extendable shaft 102 to align first hole 402 with one of the plurality of holes 502 and, thereupon, pushing the lock into lock housing 112.

In some non-limiting embodiments, second shielding component 204, second shaft member 330, and second securing hook 106b may form second locking section 500. When assembled as second locking section 500, first end 386 of second shielding component 204 may extend a distance in the range of from 0.25 inches to 1 inch past second securing hook 106b. When assembled as second locking section 500, second locking section 500 may have a length, measured by the distance between proximal end 332 of second shaft member 330 to first end 386 of second shielding component 204, in the range of from 12 inches to 15 inches.

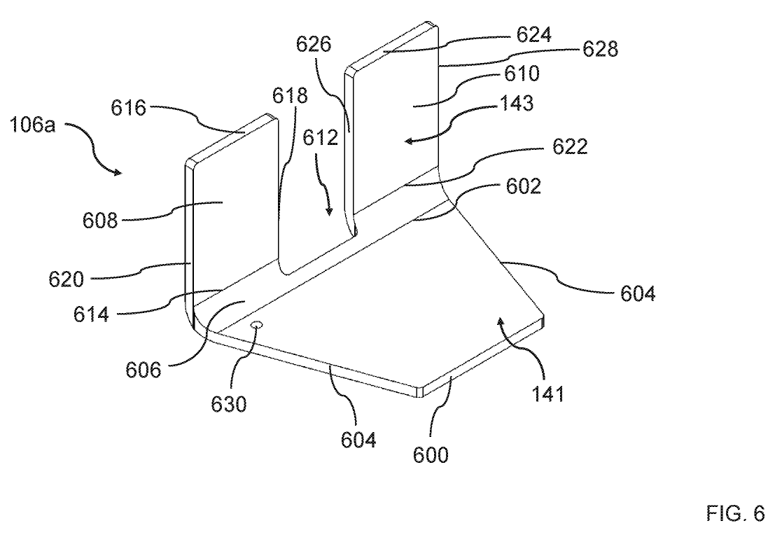

Referring to FIG. 6, first prong section 143 of first securing hook 106a may be a two-pronged hook that includes first prong 608, second prong 610, and space 612 defined between first prong 608 and second prong 610. First prong section 143 may be a two-pronged hook and may be sized and configured to fit around first rod 1010 on first door 1004 of cargo container 1000. First prong 608 and second prong 610 of first securing hook 106a may fit and be positioned above and below first bracket 1014 that holds first rod 1010 on first door 1004 of cargo container 1000. First bracket 1014 that holds first rod 1010 may be positioned in space 612 of the first securing hook 106a.

In some non-limiting embodiments, first securing hook 106a and second securing hook 106b may be the same. In some non-limiting embodiments, first securing hook 106a and second securing hook 106b may be different. First securing hook 106a may have a thickness in the range of from 0.125 inches to 0.75 inches. First securing hook 106a may include first base section 141. First base section 141 may include first end 600, second end 602, and sidewalls 604 extending between first end 600 and second end 602. A distance between first end 600 of first base section 141 and upper surface 144 of first prong section 143 may be in the range of from 5 inches to 7 inches. A distance between second end 602 of first base section 141 and upper surface 144 of first prong section 143 may be in the range of from 0.3 inches to 1 inch. First end 600 may include a width, measured by the distance between sidewalls 604 at first end 600, in the range of from 3 inches to 6 inches. Sidewalls 604 may be parallel. Sidewalls 604 may be slanted relative to first end 600. For example, sidewalls 604 may be slanted at an angle greater than 90 degrees and less than 140 degrees. A distance between first end 600 and second end 602 of first base section 141 may be in the range of from 4 inches to 6 inches. Second end 602 may have a width that is equal to the width of first end 304. Second end 602 may have a width that is greater than the width of first end 600. Second end 602 may have a width, measured by the distance between sidewalls 604 at second end 602, in the range of from 4 inches to 9 inches. First securing hook 106a may include curved portion 606. Curved portion 606 may extend radially from second end 602 of first base section 141. First securing hook 106a may include first prong section 143 that includes at least one prong, such as first prong 608 and second prong 610. First prong 608 and second prong 610 may extend a distance from curved portion 606. First prong 608 and second prong 610 may extend the same distance from curved portion 606, or may extend a different distance from curved portion 606, relative to each other. First prong 608 and second prong 610 may each independently extend a distance from curved portion 606 in the range of from 3 inches to 6 inches. Space 612 may be defined between first prong 608 and second prong 610. A distance between first prong 608 and second prong 610, which is also the width of space 612, may be in the range of from 2 inches to 5 inches.

First prong 608 may include first end 614, second end 616 opposite from first end 614, first sidewall 618, and second sidewall 620 opposite from first sidewall 618. A distance between first sidewall 618 and second sidewall 620 of first prong 608 may be in the range of from 2 inches to 4 inches. Second prong 610 may include first end 622, second end 624 opposite from first end 622, first sidewall 626, and second sidewall 628 opposite from first sidewall 626. A distance between first sidewall 626 and second sidewall 628 of second prong 610 may be in the range of from 2 inches to 4 inches. A distance between second sidewall 620 of first prong 608 and second sidewall 628 of second prong 610 may be in the range of from 7 inches to 10 inches. The distance between second sidewall 620 of first prong 608 and second sidewall 628 of second prong 610 may be the same as the length of second end 602 of first base section 141.

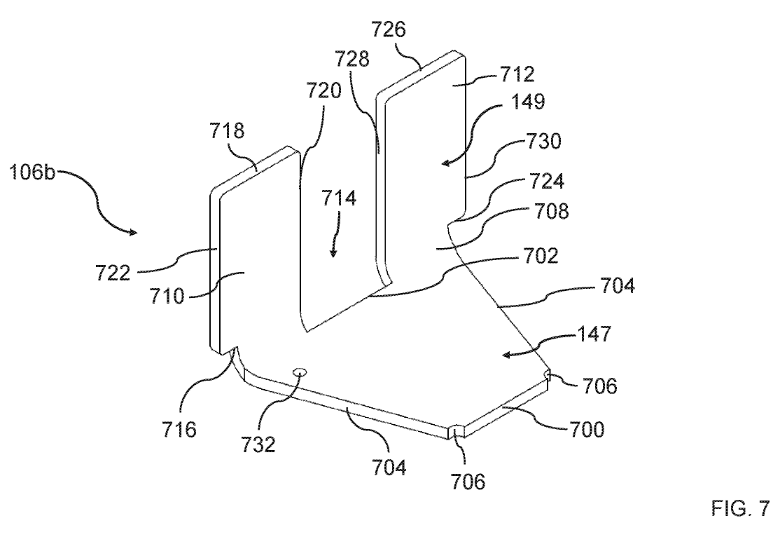

Referring to FIG. 7, second prong section 149 may be a two-pronged hook that includes first prong 710, second prong 712, and space 714 defined between first prong 710 and second prong 712. Second prong section 149 may be a two-pronged hook and may be sized and configured to fit around second rod 1012 on second door 1006 of cargo container 1000. First prong 710 and second prong 712 of second securing hook 106b may fit and be positioned above and below second bracket 1016 that holds second rod 1012 on second door 1006 of cargo container 1000. Second bracket 1016 that holds second rod 1012 may be positioned in space 714 of second securing hook 106b.

Second securing hook 106b may have a thickness in the range of from 0.125 inches to 0.75 inches. Second securing hook 106b may include second base section 147. Second base section 147 may include first end 700, second end 702, and sidewalls 704 extending between first end 700 and second end 702. A distance between first end 700 of second base section 147 and upper surface 150 of second prong section 149 may be in the range of from 4 inches to 6 inches. A distance between second end 702 of second base section 147 and upper surface 150 of second prong section 149 may be in the range of from 0.3 inches to 1 inch. First end 700 may include a width, measured by the distance between sidewalls 704 at first end 700, in the range of from 2 inches to 5 inches. Sidewalls 704 may be parallel. Sidewalls 704 may be slanted relative to first end 700. For example, sidewalls 704 may be slanted at an angle greater than 90 degrees and less than 140 degrees relative to first end 700. The corners in which first end 700 and sidewalls 704 meet may each independently be beveled, such as the corners in which first end 700 and sidewalls 704 may each independently include a concave bevel 706. A distance between first end 700 and second end 702 of second base section 147 may be in the range of from 3.5 inches to 6 inches. Second end 702 may have a width that is equal to the width of first end 700. Second end 702 may have a width that is greater than the width of first end 700. Second end 702 may have a width, measured by the distance between sidewalls 704 at second end 702, in the range of from 4 inches to 9 inches. Second securing hook 106b may include curved portion 708. Curved portion 708 may extend radially from second end 702 of second base section 147. Second securing hook 106b may include second prong section 149 that includes at least one prong, such as first prong 710 and second prong 712. First prong 710 and second prong 712 may extend a distance from curved portion 708. First prong 710 and second prong 712 may extend the same distance from curved portion 708, or may extend a different distance from curved portion 708, relative to each other. First prong 710 and second prong 712 may each independently extend a distance from curved portion 708 in the range of from 3 inches to 6 inches. Space 714 may be defined between first prong 710 and second prong 712. A distance between first prong 710 and second prong 712, which is also the width of space 714, may be in the range of from 2 inches to 5 inches.

First prong 710 may include first end 716, second end 718 opposite from first end 716, first sidewall 720, and second sidewall 722 opposite from first sidewall 720. A distance between first sidewall 720 and second sidewall 722 at second end 718 may be in the range of from 2 inches to 4 inches. Second prong 712 may include first end 724, second end 726 opposite from first end 724, first sidewall 728, and second sidewall 730 opposite from first sidewall 728. A distance between first sidewall 728 and second sidewall 730 at second end 726 may be in the range of from 2 inches to 4 inches. A distance between second sidewall 722 of first prong 710 and second sidewall 730 of second prong 712 may be in the range of from 6 inches to 8 inches. The distance between second sidewall 722 of first prong 710 and second sidewall 730 of second prong 712 may be greater than the length of second end 702 of second base section 143.

In some non-limiting embodiments, first securing hook 106a may include first powder coating hole 630 and/or second securing hook 106b may include powder coating hole 732. Powder coating hole 630 may be present on first base section 141 of first securing hook 106a. Powder coating hole 732 may be present on second base section 147 of second securing hook 106b. Powder coating hole 630 may be present on first securing hook 106a and/or powder coating hole 732 may be present on second securing hook 106b and be configured to assist in a powder coating process. In some non-limiting embodiments, cargo door lock 100 may be powder coated, with a powder coating process being aided by powder coating hole(s) 630, 732. Powder coating hole(s) 630, 732 may have a diameter in the range of from 0.125 inches to 0.5 inches.

Referring to FIG. 8, in some non-limiting embodiments, first upper section 338 and first lower section 342 may be identical, such that first upper section 338 and first lower section 342 include the same shape and size. First upper section 338 and first lower section 342 may be identical, except for housing slot 802 on first lower section 342. First lower section 342 may include housing slot 802. Housing slot 802 may have a shape that corresponds to a shape of lock housing 112, such that lock housing 112 may pass through housing slot 802 when cargo door lock 100 is assembled. Housing slot 802 may be positioned on first lower section 342 so as to receive lock housing 112 when cargo door lock 100 is assembled. Housing slot 802 may be positioned on first lower section 342, such that the furthest extent of housing slot 802 is positioned at a distance in the range of from 7 inches to 10 inches from first end 358 of first shielding component 202. Housing slot 802 may be positioned on first lower section 342, such that the furthest extent of housing slot 802 is positioned a distance in the range of from 2 inches to 4 inches from first lower section first end 362.

First upper section 338 and/or first lower section 342 may each independently include chamfer 804 at second end 360 of first shielding component 202. For example, first upper section 338 and/or first lower section 342 may each independently include chamfer 804 at second end 360 of first shielding component 202, such that the height of first upper section 338 and/or first lower section 342 drastically decreases at second end 360 of first shielding component 202.

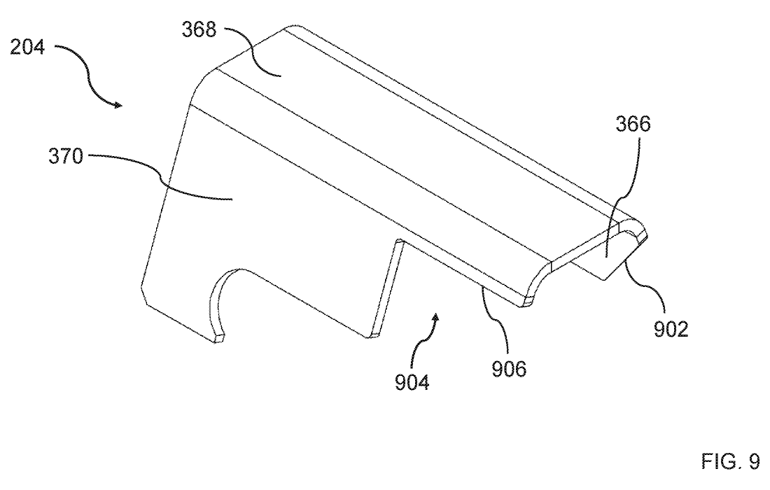

Referring to FIG. 9, second shielding component 204 may include cutaway section 904 where second lower section 370 is not present. Cutaway section 904 may extend into second lower section 370 a distance in the range of from 2 inches to 5 inches. If cutaway section 904 is present, lip 906 may extend from second middle section 368 where second lower section 370 is absent. Cutaway section 904 may have a shape and size that corresponds to a shape and size of housing slot 802 and corresponds to a shape and size of lock housing 112. When cargo door lock 100 is assembled, lock housing 112 may be capable of passing through housing slot 802 and through cutaway section 904. Second upper section 366 may include chamfer 902 at second end 388 of second shielding component 204, such that the height of second upper section 366 drastically decreases at second end 388 of second shielding component 204.

Referring to FIG. 10, cargo door lock 100 may be configured to fasten the back of cargo container 1000. Cargo container 1000 can be any suitable container capable of being fastened closed by cargo door lock 100. For example, cargo container 1000 may be a sea-rail container, a tractor-trailer container, a static container, and/or the like. Cargo container 1000 may include face 1002 that includes first door 1004 and second door 1006. First door 1004 and second door 1006 may be hinged at vertical edges 1008 of face 1002, such that doors 1004, 1006 may be opened, and meet at some point along face 1002 when closed in order to seal cargo container 1000. First door 1004 may include first vertical rod 1010, and second door 1006 may include second vertical rod 1012. First vertical rod 1010 may be secured to first door 1004 with first bracket 1014. Second vertical rod 1012 may be secured to second door 1006 with second bracket 1016. Rods 1010, 1012 may work in conjunction with levers 1018 (e.g., handles) that are used to lock and unlock doors 1004, 1006. In some non-limiting embodiments, cargo door lock 100 may be fastened to vertical rods 1010, 1012, which may prevent unauthorized use of vertical rods 1010, 1012, thereby helping to prevent unauthorized access to the interior of cargo container 1000. The predetermined length to set extendable shaft 102 may be based on the extension required to ensure securing hooks 106a, 106b are secured around vertical rods 1010, 1012.

When cargo container 1000 is carried on a tractor-trailer, the rear of cargo container 1000 may not be flush with truck bed or platform 1020 used to hold cargo container 1000, such that lip 1022 often results. Regardless of the base or ground on which cargo container 1000 sits, cargo door lock 100 may be designed to make it hard for a would be thief to get access to the lock mechanism positioned within lock housing 112. In some non-limiting embodiments, lock housing 112 may point downward in normal use, such that an operator can attach cargo door lock 100 to rods 1010, 1012 close to lip 1022, thereby making it harder for a would be thief to get lock wrecking tools into, for example, lock housing 112.

It will be readily appreciated by those skill in the art that modification may be made to the disclosure and/or embodiments without departing from the concepts disclosed in the foregoing description. Accordingly, the particular embodiments described in detail herein are illustrative only and are not limiting to the scope of the disclosure, which is to be given the full breadth of the appended claims and any and all equivalents thereof.

What is claimed is:

1. A door lock assembly for a cargo container comprising:
a first shaft member having a first securing hook;
a second shaft member having a second securing hook, wherein the second shaft member is sized and configured to couple to the first shaft member; and
a shaft member shield comprising:
a first shielding component attached to the first shaft member; and
a second shielding component attached to the second shaft member;
wherein the first shielding component is sized and configured to surround the first shaft member; and
wherein the second shielding component is sized and configured to surround the second shaft member; and
wherein the first securing hook of the first shaft member is sized and configured to fit around a first rod on a first door of a cargo container, and wherein the second securing hook of the second shaft member is sized and configured to fit around a second rod on a second door of the cargo container.

2. The door lock assembly of claim 1, wherein the first shielding component and the second shielding component overlap when the second shaft member and the first shaft member are coupled together.

3. The door lock assembly of claim 1, wherein the first securing hook comprises a two-pronged hook, wherein the two-pronged hook comprises a first prong, a second prong, and a space defined between the first prong and the second prong, and wherein the two-pronged hook is sized and configured to fit around the first rod on the first door of the cargo container and the first prong and the second prong fit above and below a bracket that holds the first rod on the first door of the cargo container.

4. The door lock assembly of claim 1, wherein the first shielding component comprises a first upper section, a first middle section, and a first lower section, and wherein the first upper section, the first middle section, and the first lower section define a first U-shaped profile that surrounds the first shaft member; and
wherein the second shielding component comprises a second upper section, a second middle section, and a second lower section, and wherein the second upper section, the second middle section, and the second lower section define a second U-shaped profile that surrounds the second shaft member.

5. The door lock assembly of claim 4, wherein the first shielding component comprises a first U-shaped open end, wherein the first securing hook comprises a first prong section and a first base section, and wherein the first base section comprises a shape that corresponds to the first U-shaped open end.

6. The door lock assembly of claim 4, wherein the second shielding component comprises a second U-shaped open end, wherein the second securing hook comprises a second prong section and a second base section, and wherein the second base section comprises a shape that corresponds to and overlaps the second U-shaped open end.

7. The door lock assembly of claim 1, wherein the second shaft member is sized and configured to fit at least partially within the first shaft member when the first shaft member and the second shaft member are coupled together.

8. The door lock assembly of claim 1, wherein the first shielding component comprises a first curved prong, and wherein the first curved prong is sized and configured to partially surround the first rod on the first door of the cargo container; and
wherein the second shielding component comprises a second curved prong, and wherein the second curved prong is sized and configured to partially surround the second rod on the second door of the cargo container.

9. A door lock assembly for a cargo container comprising:
a first lock section having a first two-pronged securing hook; and
a second lock section having a second two-pronged securing hook, wherein the second shaft member is sized and configured to couple to the first shaft member;
wherein the first two-pronged securing hook of the first lock section is sized and configured to fit around a first rod on a first door of a cargo container;
wherein the second two-pronged securing hook of the second lock section is sized and configured to fit around a second rod on a second door of the cargo container; and
wherein each of the first two-pronged securing hook and the second two-pronged securing hook comprises a first prong, a second prong, and a space defined between the first prong and the second prong, and wherein the first prong and the second prong fit above and below a respective bracket that holds a respective rod on a respective door of the cargo container.

10. The door lock assembly of claim 9, wherein the first lock section comprises a first shaft member;
wherein the second lock section comprises a second shaft member; and
wherein the second shaft member is sized and configured to fit at least partially within the first shaft member when the first shaft member and the second shaft member are coupled together.

11. The door lock assembly of claim 9, wherein the first lock section comprises a first curved prong, and wherein the first curved prong is sized and configured to partially surround the first rod on the first door of the cargo container; and
wherein the second lock section comprises a second curved prong, and wherein the second curved prong is sized and configured to partially surround the second rod on the second door of the cargo container.

12. The door lock assembly of claim 10, wherein the first lock section comprises a first shaft member and a first shielding component attached to the first shaft member;
wherein the second lock section comprises a second shaft member and a second shielding component attached to the second shaft member;
wherein the first shielding component is sized and configured to surround the first shaft member;
wherein the second shielding component is sized and configured to surround the second shaft member; and
wherein the first shielding component and the second shielding component prevent access to outward facing surfaces of the first shaft member and the second shaft member when the second shaft member and the first shaft member are coupled together.

13. The door lock assembly of claim 10, wherein the first shielding component and the second shielding component overlap when the second shaft member and the first shaft member are coupled together.

14. The door lock assembly of claim 10, wherein the first shielding component comprises a first upper section, a first middle section, and a first lower section, and wherein the first upper section, the first middle section, and the first lower section define a first U-shaped profile that surrounds the first shaft member; and
wherein the second shielding component comprises a second upper section, a second middle section, and a second lower section, and wherein the second upper section, the second middle section, and the second lower section define a second U-shaped profile that surrounds the second shaft member.

15. The door lock assembly of claim 12, wherein the first shielding component comprises a first U-shaped open end, wherein the first securing hook comprises a first prong section and a first base section, and wherein the first base section comprises a shape that corresponds to the first U-shaped open end.

16. The door lock assembly of claim 12, wherein the second shielding component comprises a second U-shaped open end, wherein the second securing hook comprises a second prong section and a second base section, and wherein the second base section comprises a shape that corresponds to and overlaps the second U-shaped open end.

17. A door lock assembly for a cargo container comprising:
a first lock section comprising a first shaft member having a first two-pronged securing hook and a first shielding component attached to the first shaft member; and
a second lock section comprising a second shaft member having a second two-pronged securing hook and a second shielding component attached to the first shaft member, wherein the second shaft member is sized and configured to couple to the first shaft member;
wherein the first shielding component is sized and configured to surround the first shaft member;
wherein the second shielding component is sized and configured to surround the second shaft member;
wherein the first two-pronged securing hook of the first lock section is sized and configured to fit around a first rod on a first door of a cargo container;
wherein the second two-pronged securing hook of the second lock section is sized and configured to fit around a second rod on a second door of the cargo container; and
wherein each of the first two-pronged securing hook and the second two-pronged securing hook comprises a first prong, a second prong, and a space defined between the first prong and the second prong, and wherein the first prong and the second prong fit above and below a respective bracket that holds a respective rod on a respective door of the cargo container.
